(19) United States
(12) Patent Application Publication
(10) Pub. No.: US 2008/0165796 A1
(43) Pub. Date: Jul. 10, 2008

(54) METHOD FOR A HEARTBEAT ALGORITHM FOR A DYNAMICALLY CHANGING NETWORK ENVIRONMENT

(75) Inventors: Christopher J. Martinez, Lake Worth, FL (US); Andrew D. Record, Durham, NC (US); Robert S. Sielken, Chapel Hill, NC (US)

Correspondence Address: CANTOR COLBURN LLP - IBM RSW, 20 Church Street, 22nd Floor, Hartford, CT, 06103, US

(73) Assignee: International Business Machines Corporation, Armonk, NY (US)

(21) Appl. No.: 11/620,310

(22) Filed: Jan. 5, 2007

(51) Int. Cl. H04L 12/43

(52) U.S. Cl. 370/458

(57) ABSTRACT

A method, article, and system for the dynamic determination of an optimal interval for the generation of a heartbeat signal by a device employed in a system with a dynamic timeout interval.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to software that manages network access and interaction, and more particularly to providing a method and article for the dynamic determination of an optimal interval for the generation of a heartbeat signal by a network device employed in a system implemented with a Network Address Translation (NAT) protocol.

2. Description of the Related Art

The continued growth of network communications, in particular the Internet, has led to the implementation of Network Address Translation (NAT). NAT refers to the situation where a limited number of network connections are used to supply network connectivity for a larger number of network devices, since not all network devices are connected at the same time. To allow a greater number of network devices/clients than available network connections, the NAT will have timeout values associated with each network device connection. If a certain period of time passes without the network device connection being used, the network device connection will be disconnected, so that a different network device can reuse the network connection. The efficient reuse and allocation of network connections, allows for the greater number of network devices than network connections.

Typical timeout values established by the NAT are in the 1-2 minute range, but there is nothing that stipulates that the timeouts can't be any number of seconds, minutes, hours, or days based on network demand and traffic conditions. If demand for network connections is high, the timeout interval will be made shorter than average, while for low demand periods the timeout interval can be made longer than average.

For network device applications that require the network connection to always be present, NAT timeouts are problematic. Network devices and applications that require a continuous network connection must generate and send a keep-alive or heartbeat signal message, at an interval less than the timeout value to keep the connection active. Currently, network devices generate and send the heartbeat signal message at a fixed interval. However, a fixed interval heartbeat signal will not optimally handle dynamically changing network environments with varying usage demand and NAT determined timeouts. In an instance of high network demand, a shorter time out interval may be introduced by the network than the established heartbeat signal interval of a network device, leading to a potentially unwanted and unexpected disconnection from the network.

### SUMMARY OF THE INVENTION

A method for the dynamic determination of an optimal interval for the generation of a heartbeat signal by a device employed in a system with a dynamic timeout interval value, having a present length, wherein the method comprises the following steps: a) defining an initial heartbeat interval X for the device, a lower bound (LB) of 0, and a confidence interval CI; b) determining a value N that satisfies 2^{N-1}<X≦2^{N}; c) determining if X is shorter than the present length of the system's dynamic timeout interval value (L), wherein if X is shorter, setting a lower bound (LB) equal to X, increasing X by X+2^{N}, incrementing N by 1, and retesting if X≦L; d) recursively repeating step c until X>L and then proceeding to step e; e) setting an upper bound (UB) equal to X; f) determining a value of UB−LB and proceeding to step m if the value is less than or equal to CI, otherwise proceed to step g; g) determining a new heartbeat interval X equal to the value of a binary search defined by (UB+LB)/2; h) determining if X≦L and proceeding to step j if X≦L, otherwise proceed to step i; i) determining if X>L and proceeding to step e if X>L; j) setting LB=X; k) determining a value of UB−LB and proceeding to step m if the value is less or equal to the CI, otherwise proceed to step l; l) determining a value of UB−LB and proceeding to step g if the value is greater than the CI; m) setting LB as the optimal interval for the generation of a heartbeat signal by the device; ii) setting LB=0, N=1, and X=X+1 following a wait period and proceeding to step c.

A system for implementing the method of the present invention, as well as, an article comprising one or more machine-readable storage media containing instructions that when executed enable a processor to carry out the method, are also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flowchart of the algorithm for dynamically and efficiently generating a heartbeat signal message according to an embodiment of the present invention.

The detailed description explains the preferred embodiments of the invention, together with advantages and features, by way of example with reference to the drawing.

### DETAILED DESCRIPTION OF SPECIFIC EMBODIMENTS

Embodiments of the present invention provide a method and algorithm for dynamically and efficiently generating a heartbeat signal in a network with dynamically changing timeout interval values. The present invention generates a dynamic heartbeat algorithm with a heartbeat signal interval that is constantly expanding and contracting to adapt to changing network conditions. The network timeout interval could change depending on how many NAT addresses are being requested—more requests could lead to a shorter timeout interval value, while fewer requests could cause the network timeout value to increase. Other applications or network devices using the same network connection (unbeknownst to the current application) would cause the timeout seen by the current application to appear longer (although the actual NAT/network timeout would not have actually changed). The application or network device of the current invention requires a constant network connection (hence, why it is trying to keep the network connection alive), therefore if the network timeout interval value were to decrease below the heartbeat interval, not increasing the heartbeat frequency would cause the application or network device to be disconnected from the network. Alternatively, if the network timeout increases (either in reality or virtually because of other application usage), sending a heartbeat message by the application or network device at the existing interval (frequency) would be wasteful, consume valuable network bandwidth, and increase the power consumption of the network device.

Having a dynamic heartbeat algorithm to adjust for these situations is a balancing act and needs to handle widely varying network timeout values. A simplistic approach might start at 1 second and then just increase the heartbeat interval by 1 second increments until it finds an interval that causes a network disconnection. If the actually timeout interval value is 1 minute, the 1 second interval approach would require 60 attempts to determine the current network timeout interval. Using an approach that increases the heartbeat interval by 2ⁿ (n=0, 1, 2, etc.) each time, and then conducting a binary search (halving the difference) between the last good interval and the first bad interval would only need 11 attempts (1, 3, 7, 15, 31, 63, 47, 55, 59, 61, 60). If the actual timeout value were even longer (say 5 minutes), the simple algorithm would be even worse. Besides finding the initial optimal interval, the algorithm would also need to adapt to changing timeout intervals. However, the algorithm doesn't want to try too often (for example, if the timeout was 60 seconds, it doesn't want to try 61 seconds every time) because the network device or application connection will fail, and there has to be some error recovery/overhead to deal with failures. Thus, the algorithm needs to be “sticky” in that it needs to stay at the optimal interval for at least a predetermined time before it tries to adjust the heartbeat signal interval.

However, once the heartbeat algorithm does decide to try and increase the interval (this could either be initiated by an automatic timed interval or through an explicit indication from the client), the chances are that the network has changed considerably, so the heartbeat algorithm needs to be able to adapt quickly to a potentially drastic change. A simplistic algorithm might try to adjust the heartbeat signal interval in 1 second increments to find the new optimal interval. However, just like the initial optimal interval discovery, the simplistic algorithm will be time and message intensive, whereas increasing the interval by 2ⁿ (n=0, 1, 2, etc.) until a missed interval is encountered, and then binary searching until the new optimal interval is found, would be able to handle both small increases (for example, 5 seconds) as well as large increases (for example, 5 minutes) equally proficiently.

The heartbeat algorithm of the present invention is able to determine both small and large network timeout intervals equally well, while minimizing the number of attempts necessary to locate the local optimal interval. The heartbeat algorithm of the present invention also avoids the overhead/cost of constantly trying to increase the interval (when it will most likely fail), and can adapt to both small and large changes in the interval equally well.

An embodiment of the general algorithm of the present invention is summarized as follows:

1. Determine a starting heartbeat interval X.
2. Find N such that 2^{N-1}<X<=2^{N}.
3. Presume some network determined timeout interval limit L.
4. While X<=L, increase X by 2^{N} and increase N by 1.
5. Once you have an X′ such that X′>L (and X<=L), do a binary search (repeatedly halving the difference) using X as the lower bound (LB) and X′ as the upper bound (UB) until X is within the confidence interval of L. X is now the “locally optimal interval”.
6. Determine how long to stay at the newly determined network timeout interval using interval X and use X for that long, before trying to determine the potentially new network timeout value. (note: one option would be that “how long” is forever, and that would still be an improvement over the current art which uses a predefined interval).
7. Presume some new limit L for the network timeout value.

### 8. Set N to 1, LB to 0, and X=X+1.

9. Return to step 4 using new L and new N.

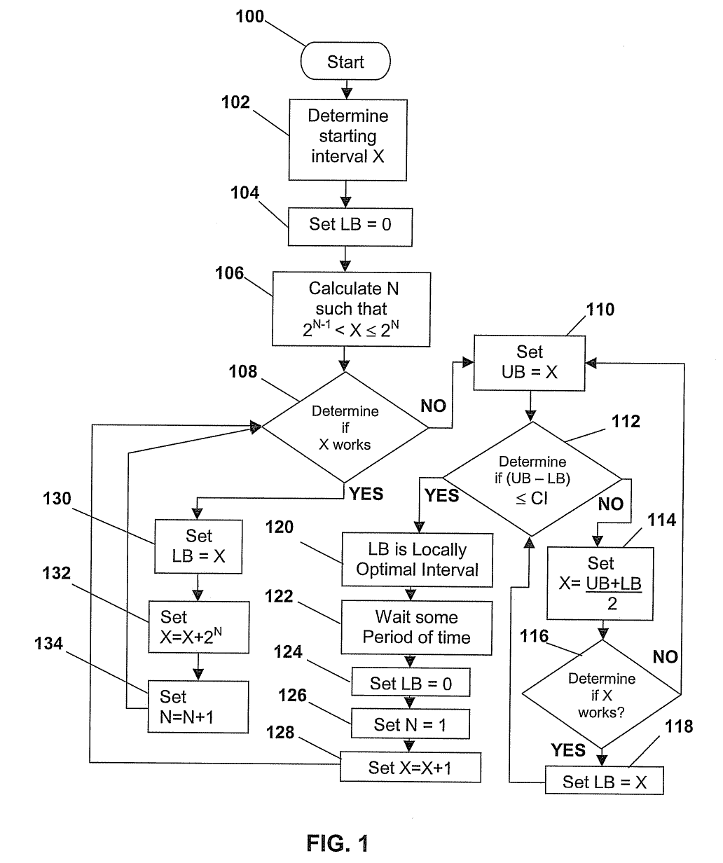

FIG. 1 is a flowchart that describes an embodiment of the heartbeat algorithm of the present invention. The flowchart will be explained in conjunction with the following numerical example.

Starting at 100 and assuming a heartbeat interval of 30 seconds (X=30) in 102, the algorithm sets the lower bound (LB) equal to zero (104), and calculates a value for N (106) so that 2^{N}−1<X<=2^{N}, which is N=5. At decision step 108, the heartbeat interval X=30 seconds is tested to see if it is less than the network timeout value (which if the device is not disconnected from the network the answer is YES), and proceeds to step 130 where the lower bound is set to 30 seconds. At step 132 the heartbeat interval X is set to 62 seconds (X=30+2⁵), and N is incremented by 1 (N=6) at step 134. Proceeding again to decision step 108 heartbeat interval X=62 seconds is tested against the present network timeout interval (which has yet to be determined) and fails (answer=NO), causing the algorithm to proceed to step 110 where the UB is set to 62 seconds. At step 112 a test is run to determine if the difference between the upper bound (62 seconds) and lower bound (30 seconds) is less than or equal to some confidence interval (CI) (in this example CI=1), which it is not. Proceeding to step 114 the heartbeat interval is determined by binary search X=(62+30)/2=46 seconds. The new heartbeat interval of 46 seconds is tested at step 116 to see if it is less than the present network time out value (which has yet to be determined), which it is, and the lower bound is set to X=46 seconds at step 118.

Proceeding again to step 112 the test involving the preset confidence interval is rerun with a negative result and results in step 114, where X is set to be the lower bound=(62+46)/2=54 seconds. At step 116 the new heartbeat interval of 54 seconds is rechecked against the present network timeout value (which has yet to be determined) and passes, triggering the lower bound to be changed to 54 seconds at step 118. The confidence interval at step 112 is now retested with another negative result and a new binary search conducted at step 114 for the heartbeat interval X=(62+54)/2=58 seconds. At step 116 the new heartbeat interval of 58 seconds is rechecked against the present network timeout value (which has yet to be determined) and passes, triggering the lower bound to be changed to 58 seconds at step 118. Proceeding again to step 112 the confidence interval test is rerun with the UB=62 and the LB=58 and again fails, initiating a new binary search at step 114 and setting the heartbeat interval to X=(62+58)/2=60 seconds. At step 116 the heartbeat interval of 60 seconds is tested and works, and results in the lower bound=X=60 seconds. At step 112 the confidence interval is retested (62−60≦CI) and fails, leading to step 114 where X is set to 61 seconds (62+60)/2. At step 116 the heartbeat interval of 61 fails against the network timeout value, and the algorithm proceeds to step 110 where the upper bound is set to 61. At step 112 the CI interval test is satisfied (61−60≦1), and the lower bound (60 seconds) is determined to be the locally optimal interval (the network timeout value).

After having determined the present timeout interval, the algorithm uses the locally optimal interval as the devices heartbeat value (X=60 seconds in this example) for a predetermined time (for example 30 minutes) at step 122. After the wait period has expired the lower bound is reset to zero at step 124, and N is set to one at step 126, and X is incremented by one second to 61 seconds. The new heartbeat interval is now tested at step 108. If the network timeout value has increased in the last 30 minutes, the lower bound is increased in step 130, the heartbeat interval is increased in step 132, and N is incremented in step 134. The new heartbeat interval is retested at step 108, and steps 130, 132, and 134 are repeated until condition test 108 fails, and step 110 and its ancillary steps are conducted as outlined in the beginning of this example. In a case where the network timeout value has decreased over the last 30 minutes the test at step 108 fails immediately, and step 110 is performed.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for the dynamic determination of an optimal interval for the generation of a heartbeat signal by a device employed in a system with a dynamic timeout interval value, having a present length, wherein the method comprises the following steps:
a) defining a heartbeat interval X for the device, a lower bound (LB) of 0, and a confidence interval (CI);
b) determining a value N that satisfies 2^{N-1}<X≦2^{N};
c) determining if X is shorter than the present length of the system's dynamic timeout interval value (L), wherein if X is shorter, setting a lower bound (LB) equal to X, increasing X by X+2^{N}, incrementing N by 1, and determining if X≦L;
d) recursively repeating step c until X>L and then proceeding to step e;
e) setting an upper bound (UB) equal to X;
f) determining a value of UB−LB and proceeding to step m if the value is less than or equal to CI, otherwise proceed to step g;
g) determining a new heartbeat interval X equal to the value of a binary search defined by (UB+LB)/2;
h) determining if X≦L and proceeding to step j if X≦L, otherwise proceed to step i;
i) determining if X>L and proceeding to step e if X>L;
j) setting LB=X;
k) determining a value of UB−LB and proceeding to step m if the value is less or equal to the CI, otherwise proceed to step l;
l) determining a value of UB−LB and proceeding to step g if the value is greater than the CI;
m) setting LB as the optimal interval for the generation of a heartbeat signal by the device; and
n) setting LB=0, N=1, and X=X+1 following a wait period and proceeding to step c.

2. The method of claim 1, wherein:
the determining, recognizing, and setting is carried out by an algorithm implemented on a networked device employed in a Network Address Translation (NAT) system.

3. The method of claim 1, wherein:
the wait period is defined by a user of the device.

4. The method of claim 1, wherein:
the wait period is defined by the device.

5. The method of claim 1, wherein:
the dynamic timeout interval value is dependent on system demand.

6. A method for the dynamic determination of an optimal interval for the generation of a heartbeat signal by a network device employed in a system implemented with a Network Address Translation (NAT) protocol that generates a dynamic timeout interval value, having a present length, wherein the method comprises the following steps:
a) defining a heartbeat interval X for the network device, a lower bound (LB) of 0, and a confidence interval (CI);
b) determining a value N that satisfies 2^{N-1}<X≦2^{N};
c) determining if X is shorter than the present length of the system's dynamic timeout interval value (L), wherein if X is shorter, setting a lower bound (LB) equal to X, increasing X by X+2^{N}, incrementing N by 1, and determining if X≦L;
d) recursively repeating step c until X>L and then proceeding to step e;
e) setting an upper bound (UB) equal to X;
f) determining a value of UB−LB and proceeding to step m if the value is less than or equal to CI, otherwise proceed to step g;
g) determining a new heartbeat interval X equal to the value of a binary search defined by (UB+LB)/2;
h) determining if X≦L and proceeding to step j if X≦L, otherwise proceed to step i;
i) determining if X>L and proceeding to step e if X>L;
j) setting LB=X;
k) determining a value of UB−LB and proceeding to step m if the value is less or equal to the CI, otherwise proceed to step l;
l) determining a value of UB−LB and proceeding to step g if the value is greater than the CI;
m) setting LB as the optimal interval for the generation of a heartbeat signal by the network device; and
n) setting LB=0, N=1, and X=X+1 following a wait period and proceeding to step c.

7. The method of claim 6, wherein:
the determining, recognizing, and setting is carried out by an algorithm implemented on the network device.

8. The method of claim 6, wherein:
the wait period is defined by a user of the network device.

9. The method of claim 6, wherein:
the wait period is defined by the network device.

10. The method of claim 6, wherein:
the dynamic timeout interval value is dependent on system demand.

11. An article comprising machine-readable storage media containing instructions that when executed by a processor enable the processor to perform a dynamic determination of an optimal interval for the generation of a heartbeat signal by a user interface employed in a system with a dynamic timeout interval value, having a present length, wherein the system comprises: computer servers, mainframe computers, and wherein the user interfaces further comprise: desktop computers, laptop computers, mobile computing devices, and mobile communication devices.

12. The article of claim 11 wherein the instructions further comprise algorithms implementing recursive routines.

13. The article of claim 12 wherein the algorithm further comprises the following steps:
a) defining a heartbeat interval X for the user interface, a lower bound (LB) of 0, and a confidence interval (CI);
b) determining a value N that satisfies 2^{N-1}<X≦2^{N};
c) determining if X is shorter than the present length of the system's dynamic timeout interval value (L), wherein if X is shorter, setting a lower bound (LB) equal to X, increasing X by X+2^{N}, incrementing N by 1, and determining if X≦L;
d) recursively repeating step c until X>L and then proceeding to step e;
e) setting an upper bound (UB) equal to X;
f) determining a value of UB−LB and proceeding to step m if the value is less than or equal to CI, otherwise proceed to step g;
g) determining a new heartbeat interval X equal to the value of a binary search defined by (UB+LB)/2;
h) determining if X≦L and proceeding to step j if X≦L, otherwise proceed to step i;
i) determining if X>L and proceeding to step e if X>L;
j) setting LB=X;
k) determining a value of UB−LB and proceeding to step m if the value is less or equal to the CI, otherwise proceed to step l;
l) determining a value of UB−LB and proceeding to step g if the value is greater than the CI;
m) setting LB as the optimal interval for the generation of a heartbeat signal by the user interface; and
n) setting LB=0, N=1, and X=X+1 following a wait period and proceeding to step c.

14. The article of claim 13 wherein a user of the user interface defines the wait period.

15. The article of claim 13 wherein the user interface defines the wait period.

16. The article of claim 11 wherein the dynamic timeout interval value is dependent on system demand.
